(19) United States
(12) Patent Application Publication
(10) Pub. No.: US 2015/0095189 A1
(43) Pub. Date: Apr. 2, 2015

(54) SYSTEM AND METHOD FOR SCANNING, TRACKING AND COLLATING CUSTOMER SHOPPING SELECTIONS

(71) Applicant: IN SITU MEDIA CORPORATION, Vancouver (CA)

(72) Inventors: Fatehali T. Dharssi, Vancouver (CA); Ashley McKay, Vancouver (CA)

(21) Appl. No.: 14/385,713

(22) PCT Filed: Mar. 18, 2013
(86) PCT No.: PCT/CA2013/000260

§ 371 Date: Sep. 16, 2014

Related U.S. Application Data
(60) Provisional application No. 61/612,130, filed on Mar. 16, 2012.
(60) Provisional application No. 61/658,369, filed on Jun. 11, 2012.

(51) Int. Cl. G06Q 30/06; G06K 9/46; G06K 9/00

(52) U.S. Cl. CPC G06Q 30/0633; G06K 9/00771; G06K 9/4652
USPC 705/26.8

(57) ABSTRACT

A method of tracking and collating items being added to and removed from a shopping receptacle comprises receiving a cue that an item is in motion, upon such cue, receiving at least one collected colour image of the item, analyzing the image to identify the item, and creating a ledger of items in the shopping receptacle, said ledger comprising the identity of each item in the shopping receptacle.

### FIELD OF THE INVENTION

The present invention relates to the field of retail purchases and more particularly to device-based, dynamic tracking of articles selected by a consumer and to checking out such selected articles.

### BACKGROUND OF THE INVENTION

Shopping checkouts in retail establishments (for example supermarkets) have changed little in many years. Customers navigate around a store, make purchase selections and place these in a store-provided shopping cart or basket. At the conclusion of shopping, the consumer engages a retail staff member at a check-out station, and that staff member “swipes” the bar codes on purchases over a scanner (or manually enters codes), bags the purchases and acquires payment from the customer.

In a move to make the check-out process more efficient for an increasingly technology-savvy population, to decrease the number of cashiers employed by stores, and ostensibly to reduce wait times at conventional check-outs, recently, some establishments have installed self service check out stations or kiosks. This permits the customer to scan and bag the purchases him/herself and in addition to make payment at the station.

An even more recent development is to let the consumer perform some of these functions as he/she moves about the store. Commercial retailers currently use hand-held devices like smart-phones to allow customers to personally scan products prior to adding them to a shopping cart. Consumer studies show a significant number of consumers prefer to use this type of handheld self-scanning method since the devices (especially systems that use the consumer's own Smartphone) are easy to use. Additionally, other studies show this method increases the sales per order and reduces and the amount of time a consumer spends in a store location.

Retail outlets (such as supermarkets, drug stores, superstores, etc.) generally use two types of systems to motivate customers to personally scan bar-coded items to reduce use of cashier labor. These are:
Self-checkout lanes where a customer personally takes items from a shopping cart to deposit in a basket adjacent to a scanner for scanning. The customer then scans the items and puts these in a basket on the other side of the scanner. These systems currently reduce loss of items by comparing weights of products in a basket before being scanned to those in a second post-scanning basket.
Hand-held scanning devices like Smartphones with cameras which are used by a customer to scan bar-code marked items. Using this system, the customer picks products from the shelf, scans the bar-code, and deposits the product into a grocery cart. Prior to leaving the store location, a customer usually passes through a payment kiosk station and the payment for the full list of groceries purchased via credit card or a prearranged payment method configured on the Smartphone or the mobile device.

The current self-serve checkout lanes methodology of requiring a consumer to transfer products in a weighed basket to another basket after scanning at the checkout, results in numerous consumer mistakes. Accordingly, per consumer surveys, about half of consumers dislike such systems and refuse to use the self-serve checkout system.

These self-serve interactive checkout systems account for 20%-30% of checkout lanes in stores where such systems are installed. However, popularity of this checkout method is waning due to consumer usage issues. Some major retail chains have halted introduction of self-serve checkout lanes in new stores while some chains are removing these systems from existing stores in an attempt to improve consumer satisfaction.

Overall, there is a lack of consumer motivation to use the station or kiosk self-serve check outs due to the perception that such a process might be even more time consuming than using an efficient trained human cashier and the frustration with repeated error messages at these kiosks. In areas and within stores where there actually is acceptance and user uptake, there is also frustration as the lines for kiosks become as long or longer in some cases than the lines for human cashiers. The upside for customers becomes severely limited.

In contrast, the use of self-serve checkout hand-held devices is gaining popularity with consumers. These mobile scanners have the advantage of requiring negligible investment from the retailer. The comparative costs of retailers' self-scanning checkout lanes are several times higher than consumer Smartphones integrating a scanning system.

This works by a consumer using a bar code scanner app in his/her own Smartphone to scan each grocery item being purchased, in situ, as the item is placed in the cart or basket. These apps synchronize with loyalty cards, track shopping budgets and provide other rewards.

The first supermarket company in the United States to make this available to customers is the Stop & Shop Supermarket Company LLC, with its Scan It! mobile app service. This started with three grocery stores and there are plans to roll out the capability to 45 more of its stores in Massachusetts, Rhode Island and Connecticut.

To use the app to scan groceries, the consumer aims the camera of the mobile phone at the bar code of a grocery item to see the price on the phone screen and to add it to an electronic shopping basket. When the consumer has finished shopping, the bar code scanner app transmits the information via the supermarket's Wi-Fi network to the point of sale, where the consumer pays as he/she would normally. The same wireless network also allows the retailer to send the consumer personalized information and offers.

As good as it sounds, there is one major issue, yet to be adequately addressed: these known self scanning handheld systems lack an automated security system to verify that all items in a cart are scanned. One current security solution requires a store cashier to randomly or statistically select a small sample of customers to audit their purchases in detail. However, this method creates consumer dissatisfaction and is not effective during heavy traffic in a store. It also creates a consumer feeling of being targeted. Accordingly, an automated item verification method is needed to complement consumer hand-held scanning.

It is an object of the present invention to obviate or mitigate all or some the above disadvantages.

### SUMMARY OF THE INVENTION

The present invention provides a method of tracking and collating items being added to and removed from a shopping receptacle which comprises:
a) receiving a cue that an item is in motion;
b) upon such cue, receiving at least one collected colour image of the item;
c) analyzing the image to identify the item; and
d) creating a ledger of items in the shopping receptacle, said ledger comprising the identity of each item in the shopping receptacle.

The present invention further provides a method of tracking and collating items being added to and removed from a shopping receptacle which comprises:
a) receiving a first cue that a first item is in motion;
b) upon such cue, receiving at least collected colour image of the first item;
c) analyzing the image to identify the first item;
d) creating a first stable ledger of all items in the shopping receptacle;
e) receiving a second cue that a second item is in motion
f) upon such cue, receiving at least one collected colour image of the second item;
g) analyzing the image to identify the second item; and
h) creating a second, updated, stable ledger of items in the shopping receptacle.

The present invention further provides a method of tracking and collating items being added to and removed from a shopping receptacle and checking out such items from a retail operation which comprises:
a) acquiring data from a shopper operated portable device, said data comprising a colour camera scan of an individual item sought to be purchased;
b) analyzing the image to identify the individual item (creating an item image identity);
c) repeating steps a) and b) on second and subsequent items, thereby creating a collated list of identified items;
d) intermittently acquiring further data from a shopper operated portable device, said data comprising colour camera scans of contents of the shopping receptacle (creating a receptacle inventory image);
e) comparing the collated list of identified items to at least one receptacle inventory image; and
f) identifying discrepancies there between.

The present invention further provides a method of tracking and collating items being added to and removed from a shopping receptacle by a shopper and checking out such items from a retail operation which comprises:
a) linking a shopper operated portable device with the receptacle;
b) scanning, using a shopper operated portable device, a bar code of an item prior to or during placement of the item in the receptacle and storing inventory of scanned items (“scanned receptacle inventory”);
c) verifying that the item placed in the receptacle is bar code scanned, by at least one of the following means: i) acquiring data from the shopper operated portable device, said data comprising a colour camera image scan of the item in the receptacle, analyzing the image to identify the individual item (creating an item image identity); and ii) acquiring data from an image capture device in the vicinity of the receptacle, said data comprising a colour camera image scan of the item in the receptacle, analyzing the image to identify the individual item (creating an item image identity), either or both i) and ii) creating a “receptacle image inventory”:
d) repeating step b) and step c) on any second and subsequent items placed in the receptacle, thereby creating a collated list of identified items;
e) comparing the scanned receptacle inventory to at least one image within the receptacle image inventory; and
f) identifying discrepancies there between, thereby flagging an item in the receptacle image inventory but not in the scanned receptacle inventory.

The present invention further provides a shopping receptacle system comprising: a) at least means attached to the receptacle or in the vicinity of the receptacle to detect movement of an item being inserted into and removed from the receptacle and b) at least means to capture and identify an image of the item. In one aspect, one or both of a) and b) are detected by way of a shopper operated portable device (for example, a personal processing device or a Smartphone) which acquires and analyzes, multiple images of an environment of the receptacle.

Through an analysis of sequential images gathered by the shopper operated portable device (whether continuously or intermittently), it is possible to detect movement of an item into or from the receptacle.

The present invention further provides a shopping receptacle which comprises or is in the operative vicinity of at least one means to detect movement of an item being inserted into and removed from the cart, said receptacle also being in operative engagement with at least means to capture and identify an image of the item.

The present invention further provides a method of tracking and collating items being added to a shopping receptacle, wherein items are placed in a bag within the shopping receptacle and thereafter checking out such items from a retail operation which comprises:
a) acquiring a barcode of an item sought to be purchased, before item is placed in the bag, to create a bar code ledger;
b) receiving a first cue that the item is in motion, as item is placed in the bag;
c) upon such cue, acquiring at least one collected colour image of the item;
d) analyzing the image to identify the individual item (creating an item image identity ledger);
e) comparing the bar code ledger and item image identity ledger; and
f) identifying any discrepancies there between.

The present invention further provides a retail system comprising a payment terminal, retail processor and retailer supplied shopping receptacle which comprises or is in the vicinity of at least one means to detect movement of an item as such item is inserted into and/or removed from the cart and comprises or is in the vicinity of at least one means to capture and identify an image of said item; said system further comprising a means to store a ledger of all captured images and means to identity each item based on said image, its price, and means to convey all data to retail processor over a communication network.

The present invention further provides a non-transitory computer storage medium encoding instructions that when executed by data processing apparatus cause the data processing apparatus to perform operations which comprises:
a) receiving a cue that an item is in motion;
b) upon such cue, receiving at least one collected colour image of the item;
c) analyzing the image to identify the item; and
d) creating a ledger of items in the shopping receptacle, said ledger comprising the identity of each item in the shopping receptacle.

The present invention further provides a non-transitory computer storage medium encoding instructions that when executed by data processing apparatus cause the data processing apparatus to perform operations which comprises:
a) receiving a first cue that a first item is in motion;
b) upon such cue, receiving at least collected colour image of the first item;
c) analyzing the image to identify the first item;
d) creating a first stable ledger of all items in the shopping receptacle;
e) receiving a second cue that a second item is in motion;
f) upon such cue, receiving at least one collected colour image of the second item;
g) analyzing the image to identify the second item; and
h) creating a second, updated, stable ledger of items in the shopping receptacle.

The present invention further provides a non-transitory computer storage medium encoding instructions that when executed by data processing apparatus cause the data processing apparatus to perform operations which comprises:
a) acquiring data from a shopper operated portable device, said data comprising a colour camera scan of an individual item sought to be purchased;
b) analyzing the image to identify the individual item (creating an item image identity);
c) repeating step a) and b) on second and subsequent items, thereby creating a collated list of identified items;
d) intermittently acquiring further data from either the shopper operated portable device or image capture devices in the vicinity of the receptacle, said data comprising colour camera scans of contents of the shopping receptacle (creating a receptacle inventory image);
e) comparing the collated list of identified items to at least one receptacle inventory image; and
f) identifying discrepancies there between.

The present invention further provides a non-transitory computer storage medium encoding instructions that when executed by data processing apparatus cause the data processing apparatus to perform operations which comprises:
a) acquiring a barcode of an item sought to be purchased, before item is placed in a bag, to create a bar code ledger;
b) receiving a first cue that the item is in motion, as item is placed in the bag;
c) upon such cue, acquiring at least one collected colour image of the item;
d) analyzing the image to identify the individual item (creating an item image identity ledger);
e) comparing the bar code ledger and item image identity ledger; and
f) identifying any discrepancies there between.

The present invention further comprises a system for tracking and collating items being added to and removed from a shopping receptacle comprising:
a) a primary micro-processor within a motion detection device which receives data from a motion detector sensor that an item is in motion (in or out of receptacle);
b) the secondary micro-processor within an image capture device which receives a cue from the primary microprocessor that an item is in motion thereby triggering said secondary processor to i) capture an image of said item via an image capture means; ii) receive at least one collected colour image of the item; iii) analyze the image to identify the item; and iv) create a ledger of items in the shopping receptacle, said ledger comprising the identity of each item in the shopping receptacle.

One key advantage of this method and system is invention relates to security and anti-theft in the context of self-serve check outs. By way of the dynamic item image identification and the creation of the receptacle inventory, there is provided an accurate and continually updated (current) profile of what remains in a receptacle, layer by layer, at any given time. The currently employed systems do not include any means of checking or verifying shopping receptacle contents or comparison to items actually scanned by a consumer to prevent losses. The present invention provides an automated and passive system to verify shopping cart contents to prevent pilferage and losses.

These and other advantages will become apparent throughout the balance of the disclosure and claims.

### DESCRIPTION OF THE FIGURES

The following figures set forth embodiments in which like reference numerals denote like parts. Embodiments are illustrated by way of example and not by way of limitation in all of the accompanying figures.

FIG. 1 is a flow chart of the preferred steps of tracking, collating and checking out items from a store, wherein items are self-scanned by a user, said user employing a portable electronic device to do so;

FIG. 2 is a flow chart of the preferred steps of tracking, collating and checking out items from a store, wherein items are automatically analyzed by a store-provided shopping receptacle/vehicle; and

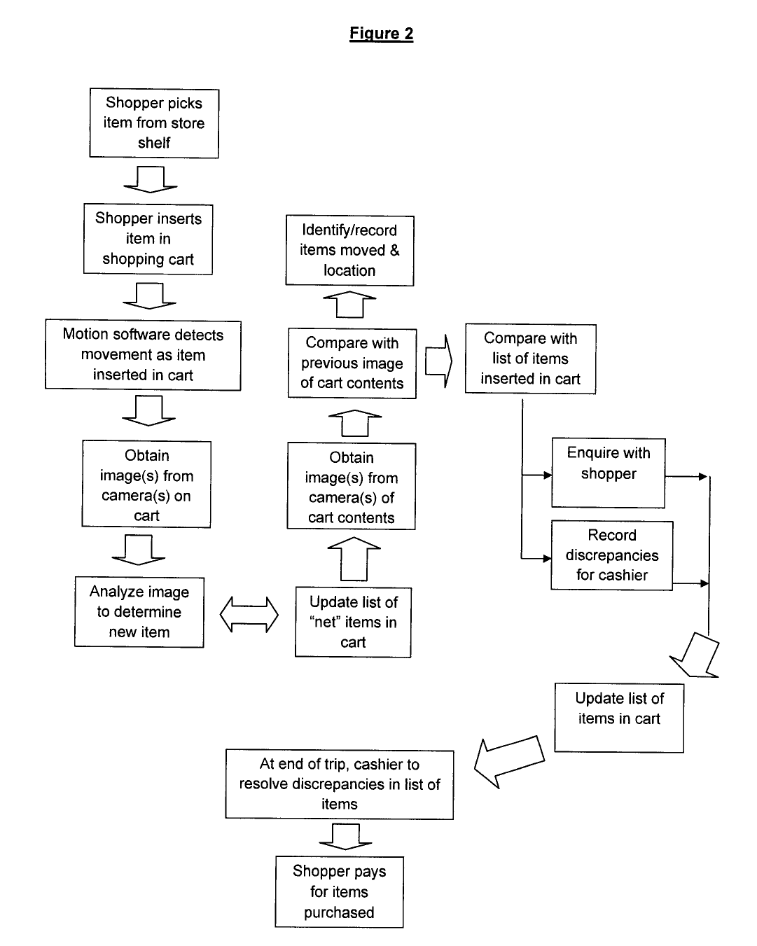

FIG. 3 is a flow chart of the preferred steps of tracking, collating and checking out items from a store, wherein items are self scanned by a user and automatically analyzed by image capture devices (for example camera(s)) which are installed on the store-provided receptacle/vehicle or in the vicinity of a store-provided shopping receptacle/vehicle and wherein items are bagged upon placement in shopping receptacle/vehicle.

### PREFERRED EMBODIMENTS OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

This description of preferred embodiments is to be read in connection with the accompanying drawings, which are part of the entire written description of this invention. In the description, corresponding reference numbers are used throughout to identify the same or functionally similar elements. If and when used herein relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral”, “adjacent” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the image of an item is captured by an image capture device, for example a camera, the term “for example” explains that “camera” is an example of “an image capture device” through which one aspect of the data collection of this invention operates.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains.

In this specification the terms “comprise, comprises, comprised and comprising” and the terms “include, includes, included and including” are deemed to be totally interchangeable and should be afforded the widest possible Interpretation.

In this specification the term Smartphone refers to any personal mobile computing device and personal data device with a camera function, including, but not limited to those operating under the following brands: iPhone®, iPad®, Android®, Nokia N97, Blackberry®, HTC, Samsung, Galaxy, Alcatel, O2 etc. . . .

As used herein the terms “shopping receptacle” or “receptacle” are to be accorded wide meaning and refer to any container or cart (wheeled or not) which is provided by a merchant for use by a customer to gather and carry items for purchase. It is to be understood that two core aspects of the invention a) motion detection of an item both into and out of receptacle (via at least one motion detector on or within the receptacle or within the vicinity of the receptacle) and b) item image capture (via at least one image capture device) may be achieved by all such devices being retrofit onto customer provided (as opposed to merchant-provided) receptacles. Furthermore, and in the alternative, it is to be understood that the motion detector and image capture device need not form part of or be attached to the receptacle as long as they are i) in the vicinity of the receptacle at the time an item is being placed in the receptacle and/or removed from the receptacle and ii) are configured and/or oriented (in the case of the image capture device) to capture an image of an item being placed in the receptacle and/or removed from the receptacle and (in the case of the motion detector) to detect motion of an item being placed in the receptacle and/or removed from the receptacle. Shopping receptacle may be used interchangeably with and includes shopping cart, and shopping basket.

As used herein the term “vicinity” is to be accorded a wide meaning commensurate with the method and system as described herein. For example, in the “vicinity” of a receptacle refers, for example, to a store ceiling, store shelf, a wall, a floor, display cases, signage or other physical landmarks which are in close enough proximity to the receptacle to have an image capture device at that vicinity to capture either or both of motion detection cues or image capture data. Many retail operations will not wish or have the means to retrofit every shopping receptacle with an image capture device (for example a digital camera) due to the cost (due to theft of receptacles) and the risk of damage (hard use by consumers). Using technology that is readily available today, image capture devices may be installed in a plurality of locations throughout the retail operation, each device trained in a direction to capture images of passing receptacles (for example shopping carts). As described further herein, in processing the back end image data received in the system by the image capture device, each particular receptacle is identified and distinguished from other receptacles.

In this specification and within the context of acquiring further data from a shopper operated portable device, the term “intermittent” or “intermittently preferably refers to a time frame interval of from about 1 second to 10 minutes but may go outside this range as it is primarily based and calculated relative to the speed by which a consumer adds items to a shopping receptacle. The faster this addition occurs, the more frequent will be the occurrence of such further data collection. They are linearly aligned.

In this specification the term scan or scanning or scanner is not just intended to refer to bar code or QR code reading but also refers to the specific image capture and identification described in detail herein.

In this specification the means by which cues are created, indicating that an item is in motion may be achieved several ways. In one embodiment, motion sensors may be attached to or installed in the vicinity of the shopping receptacle. For example, motion sensors may be installed (as part of the system of the present invention) on a store ceiling, on a store shelf, on a wall, on a floor, on display cases, on adjacent signage, etc. . . . ) Motion sensing may also be detected by the analysis of sequential images by an image capture device. Acquisition of such data and analysis of such data by a computer processor (for example in situ at the retail operation or remotely, for example via cloud computing) creates a) image inventory ledge and/or b) receptacle image inventory. The crux of the invention is the method of identifying what has been placed in or removed from the receptacle as compared to the bar codes scanned by shopper, the sum of such bar codes (and item prices) reflecting the total amount owed by the shopper at the conclusion of shopping at the retail operation. This method obviates the need for the shopper to line up and have a kiosk cashier scan and bag each item and take payment. It is also a means by which a retail operation can reduce theft of items which may be placed in a receptacle but not bar code scanned (for price input) by the shopper.

It is also to be understood that bar code scanning may not be required if image detection is sufficient to individually identify each item.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows

The present invention provides a system for tracking and collating items being added to and removed from a shopping receptacle comprising:

a) a primary micro-processor within a motion detection device which receives data from a motion detector sensor that an item is in motion (in or out of receptacle); and
b) a secondary micro-processor within an image capture device which receives a cue from the primary microprocessor that an item is in motion thereby triggering said secondary processor to i) capture an image of said item via an image capture means; ii) receive at least one collected colour image of the item; iii) analyze the image to identify the item; and iv) create a ledger of items in the shopping receptacle, said ledger comprising the identity of each item in the shopping receptacle.

In one aspect, one or both of motion detection device and image capture device are attached to and form part of receptacle. In another aspect, one or both of motion detection device and image capture device not are attached do not form part of receptacle but are in a vicinity of the receptacle. Preferably, the image capture device is a camera, selected from the group consisting of:

a) at least one 3D camera on or in the vicinity of the shopping receptacle;

b) at least one 2D camera on or in the vicinity of the shopping receptacle; or

c) a combination of 3D and 2D cameras on or in the vicinity of the shopping receptacle.

In one aspect, the image capture device is part of a personal mobile computer device, for example, a Smartphone.

In one aspect, the primary microprocessor and the secondary microprocessor are securely connected for data sharing over the internet. In another aspect, the primary microprocessor and the secondary microprocessor are securely connected for data sharing over an intranet.

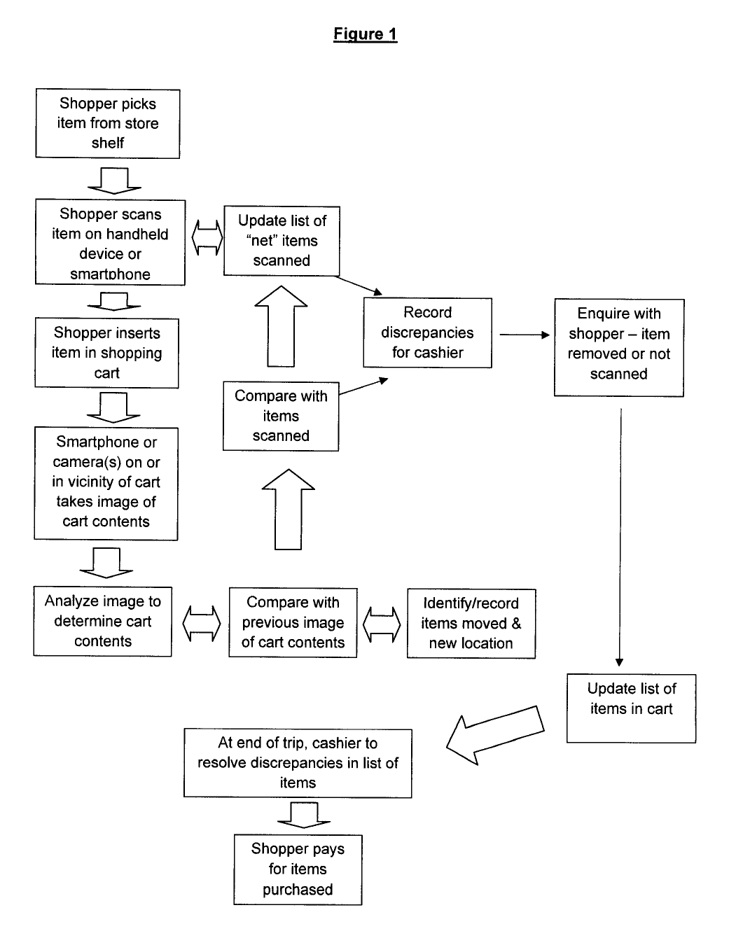

It is important to understand that there are at least two core ways in which the method, system and ultimate goals of the present invention can be implemented. The first (as shown via flowchart in FIG. 1) is via the use of consumer's portable devices such as Smartphones. This is not about scanning bar codes and simply preparing items for checkout. It is about a consumer committing to a new retailer supplied application on his/her portable device which ensures that an image is taken of the receptacle as items are placed in or removed from receptacle. As part of the method of this aspect of the invention, and using a means of image recognition, which is not, as described further herein, a bar code reading, an intelligent analysis is made as to the identity and size of the item (box of Cheerios vs. milk tetrapak vs. can of soup) therein creating (through continual monitoring) a “ledger” of total items in the receptacle. This “ledger” is referred to, interchangeably herein as the “collated list of identified items”.

As each new item is placed in the receptacle or removed there from, a comparison is made (old ledger vs. new ledger) and additions or omissions recorded. At the end of a shopping trip, any discrepancies (between for example, the number of individual items scanned by the consumer during shopping and those actually present in the receptacle at the conclusion) will be electronically signaled to the retailer for follow up with the consumer. Before such a consumer with discrepancies leaves the store, a store employee can approach the consumer and seek to correct the error. Using this method, random, ineffectual spot checks by retail employees will become obsolete. The only consumers checked will be those electronically “flagged” as having a mismatch between the number of individual items scanned by the consumer during shopping and those actually present in the receptacle at the conclusion, all of which would be done with the consumer's own portable electronic devices. The checks and balances system would both be supplied to the retailer by data acquired by the consumer using his/her portable device.

In practice, this step of identifying discrepancies is achieved by intermittently acquiring further data from a shopper operated portable device, said data comprising (for example) colour camera scans of contents of the shopping receptacle (creating a “receptacle inventory image”); comparing the collated list of identified items to at least one receptacle inventory image and thereafter identifying discrepancies between the two. Such cameras (for example, 2D and/or 3D cameras) may be placed on a shopping receptacle or in the vicinity thereof (for example, on a store ceiling, on a store shelf, on a wall, on a floor, on display cases, on adjacent signage, etc.) of a receptacle. If a camera is not attached to a shopping receptacle, a camera image can be associated to a particular receptacle by various methods such as, for example: 1. Precise timing of an item scanned which is also identified by motion detectors or analysis to be inserted in a particular receptacle or by a particular pattern of items identified in a receptacle, 2. via marks, barcodes, special patterns, diagrams or other identifying markers placed on shopping receptacles, which are identifiable/readable by image analysis.

The second aspect according to the present invention, although similar in end goal, is passive (i.e. it does not require active involvement of the user or consumer but involves independently operating tracking systems which are part of the shopping receptacle) and uses cues that an item is in motion coupled with, at least one collected colour image of the item in order to create a dynamic collated lists of identified items and receptacle inventory images. Put another way, the combination of motion analysis and passively taking images of the receptacle contents to create images of “layers” of items and comparing one layer to the next to determine changes there between.

In one preferred form, the present invention provides a method to electronically verify products that are taken from a shelf by a consumer, scanned with a hand-held device, a smart-phone or a camera installed on the cart or in the vicinity of the cart, and placed into a shopping cart. Under this invention, the data on items scanned by the consumer obtained from the hand-held device or from a small camera installed in the cart, would be checked with the data from analyzing multiple pictures and video (referred to hereinafter as images) obtained from cameras in the Smartphone and those installed on or near the shopping cart. Images of the items in the cart are taken from several viewing angles so that all items in the cart are fully or partially visible.

These images undergo further analysis to determine if the graphical attributes of the items in the cart and match these to a reference list to verify the identity of items. The graphical properties are tracked using conventional computer vision recognition software, and may undergo additional pel or pixel data pattern recognition analysis. Accordingly, the identity of the item is determined once data scanned by the consumer is compared to known historical references to an item's physical appearance. Sample images of the physical appearance of an item can be made using a camera on hand-held device, a smart-phone, or separately installed on or in the vicinity of the receptacle. Thus, when differences arise between the list of items scanned by the consumer and the list created from the graphical analysis of the images obtained of the items in the cart, a notice message could be generated for the consumer or the checkout monitoring staff to check for missing items.

Data of item identity derived from successive images obtained for graphical analysis can continuously be checked to the list of items scanned by the consumer. Accordingly, comparing newly scanned data against the historical appearance of the currently selected contents helps isolate new items for analysis. Known items can therefore be excluded from a cart as items shift in position or get obscured by another item clearly visible in previous images. Furthermore, a 3D camera can provide volumetric data in addition to the visual image data fed into the scanning verification system. Items taken out of the cart would be excluded from the known history of the order verification list, but a complete sequential image set would be used to track each item's history as a consumer's shopping trip progresses. Therefore this process continuously updates the accumulated content history, and provides data for the retail outlet to handle and communicate with consumer discrepancies in scanned items.

For example, if analysis shows that a Coke soda was scanned than the exact package type of Coke could be determined based on the graphical image properties, UPC bar-code, or 3 dimensional properties of the packaging. Another perspective on package size could be obtained by comparing the item dimensions in an image with the shopping cart grid formed on the walls and bottom of the shopping cart cage. Accordingly, data about the package type of a particular product can be determined from the image, the comparative data obtained of the cart cage grid and or image information. This data can then be used to verify specific items scanned by a consumer to ensure consistency.

In a preferred aspect, there is provided herein a method of tracking and collating items being added to and removed from a shopping receptacle by a shopper and checking out such items from a retail operation which comprises:
a) linking a shopper operated portable device with the receptacle;
b) scanning, using the shopper operated portable device, a bar code of an item prior to or during placement of the item in the receptacle and storing inventory of scanned items (“scanned receptacle inventory”);
c) verifying that the item placed in the receptacle is bar code scanned, by at least one of the following means: i) acquiring data from the shopper operated portable device, said data comprising a colour camera image scan of the item in the receptacle, analyzing the image to identify the individual item (creating an item image identity); and ii) acquiring data from an image capture device in the vicinity of the receptacle, said data comprising a colour camera image scan of the item in the receptacle, analyzing the image to identify the individual item (creating an item image identity), either or both i) and ii) creating a “receptacle inventory image”:
d) repeating step b) and step c) on any second and subsequent items placed in the receptacle, thereby creating a collated list of identified items;
e) comparing the scanned receptacle inventory to at least one receptacle inventory image; and
f) identifying discrepancies there between, thereby flagging an item in the receptacle inventory image but not in the scanned receptacle inventory.

In a preferred form, a shopper operated portable device is equipped with an application enabling operation one or more of steps a) to e). In a preferred form, a shopper operated portable device is a Smartphone. In a preferred form, a shopper operated portable device is linked to the receptacle by scanning (using the device) an identifying feature of the receptacle and wherein said application enables a connection between the receptacle and the device. In a preferred form, the shopping receptacle is a shopping cart or a shopping basket. In a preferred form, the step of analyzing the image to identify the individual item is via pattern analysis. In a preferred form, the step of analyzing the image to identify the individual item is via at least one of the following means:
pel or pixel pattern analysis
graphic image recognition
3D analysis of packaging of the item
comparison of size and orientation of the item in the receptacle to a known feature of the receptacle

In a preferred form, the colour camera image scan of the item in the receptacle is created by one or more 3D cameras, one or more 2D cameras or combinations thereof thereby providing volumetric data for use in analyzing the image. In a preferred form, the colour camera image scan of the item in the receptacle is identified by comparison to known historical references relating to other items having at least a similar physical appearance. In a preferred form, there comprises an addition step of storing the ledger and identity of each item, including price of each item, until recalled for checkout at a payment terminal. In a preferred form, the image capture device in the vicinity of the receptacle is located at (at least) one of the following locations in the retail operation: a ceiling, a floor, wall, a shelf, on signage, on a corner, attached to any fixture, attached to other items for sale; on posts, on displays, on remote robotic apparatus, and on employees. In a preferred form, verifying that the item placed in the receptacle is bar code scanned is by at least one of the means of:
i) acquiring data from the shopper operated portable device, said data comprising a colour camera image scan of the item in the receptacle, analyzing the image to identify the individual item (creating an item image identity); and
ii) acquiring data from an image capture device in the vicinity of the receptacle, said data comprising a colour camera image scan of the item in the receptacle, analyzing the image to identify the individual item (creating an item image identity), either or both i) and ii) creating a “receptacle inventory image”
   by which images are continually captured.

In a preferred form, verifying that the item placed in the receptacle is bar code scanned is by at least one of the means of i) and ii) (above) by which images are intermittently captured.

In a preferred form, at verification step c) ii) above, the image capture device in the vicinity of a receptacle identifies a particular receptacle (as compared to other receptacles in the retail operation) by at least one of the following:
a receptacle identification code
a receptacle identification feature
a comparison of a last scanned item at step b)
a comparison to a total inventory of scanned items at step b)

In a preferred form, image acquisition within the scope of the present application may be via:
1. one or more 3D cameras on or in the vicinity of the shopping receptacle;
2. one or more 2D cameras on or in the vicinity of the shopping receptacle; or
3. a combination of 3D and 2D cameras on or in the vicinity of the shopping receptacle.

The dual concepts of i) motion detection and ii) multi-layer image capturing/analysis/identification/collation/comparison are important elements of this second embodiment. As such, how images are captured is important. 3D cameras are, of course, excellent for distinguishing height and depth but are currently less useful in assessing colour. 2D cameras are excellent in colour analysis. It is preferred that two or more 2D cameras be used on the shopping receptacle or placed in strategic locations on in-aisle shelves, shelf corners, store walls and ceilings, which can, when properly positioned, give height and depth information in respect to an item inserted in a cart and further can provide useful colour data, the combination of which make identification more straightforward.

An example of this may be instructive: Tropicana brand orange juice is sold in a tetrapak which is of a virtually identical shape to milk and other juice brands. It would be useful in identifying the item as a Tropicana brand orange juice to acquire colour based information on the product.

In one preferred embodiment of this invention, a camera is placed on or in the vicinity of the shopping receptacle or the hand-held device. For example, one camera would be in the smart-phone and/or one or more small camera(s) could be placed in certain locations in the receptacle or placed in strategic locations on in-aisle shelves, shelf corners, store walls and ceilings so as to get images of the items in the cart from different angles. Additionally, a receptacle may also have graphical markers like a line painted with a specific color pattern on parts like the perimeter of the receptacle. The image analysis software could then quickly determine any part of the image that is external to the actual receptacle. Thus, during a shopping trip the sample images may be obtained periodically with motion detection, intermittently or captured as a continuous stream. A retailer may prefer not to install expensive image capture devices such as cameras on a receptacle but in the alternative install these devices in strategic locations on in-aisle shelves, shelf corners, store walls and ceilings, since shopping receptacles (like carts) in retail stores tend to get stolen, are frequently used outside the stores in parking lots and tend to be aggressively used physically.

In another embodiment of this invention, the shopper and/or the store may prefer to bag the groceries when these are placed in a shopping receptacle. As such, this method provides that a retail operation can track and collate items being added to a shopping receptacle, wherein items are actually placed in a bag within the shopping receptacle and thereafter checking out such items from a retail operation which comprises: acquiring a barcode of an item sought to be purchased (before item is placed in the bag) to create a bar code ledger; receiving a first cue that the item is in motion, as item is placed in the bag; upon such cue, acquiring at least one collected colour image of the item; analyzing the image to identify the individual item (creating an item image identity ledger); comparing the bar code ledger and item image identity ledger; and identifying any discrepancies there between.

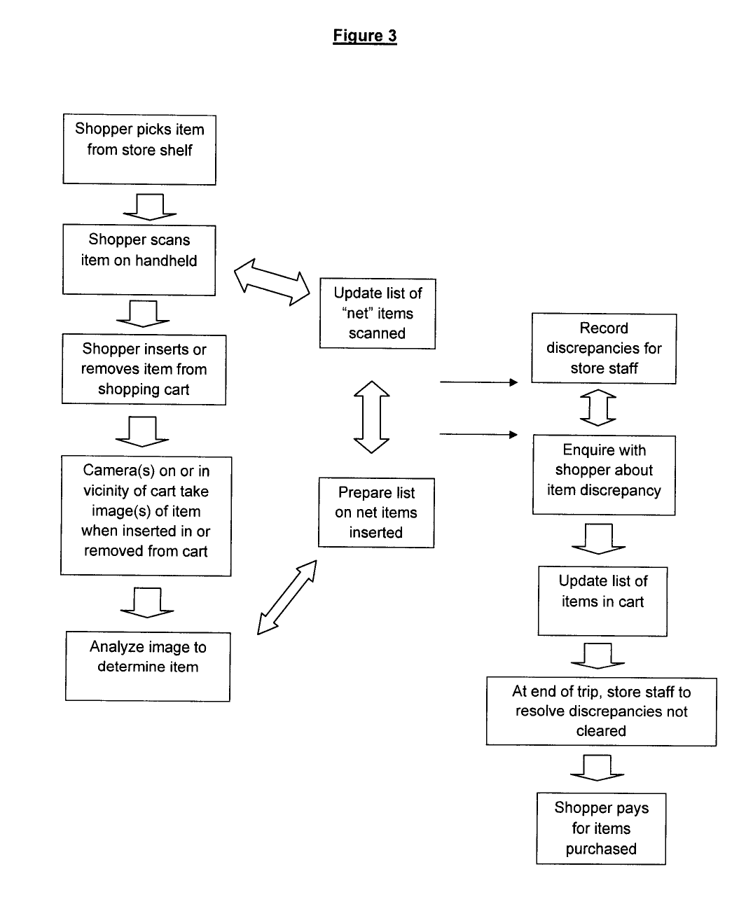

FIG. 3 is a flow chart of this embodiment, showing the sequential steps of tracking, collating and checking out items from a store, wherein items are self scanned by a user and automatically analyzed by a store-provided shopping receptacle/vehicle and wherein items are bagged upon placement in shopping receptacle/vehicle. In particular, a shopper selects an item from a shelf and scans said item with a personal electronic device having a barcode scanning function. Thereafter, a bar-code ledger is populated with the scan data. As a second step, the shopper places the item into a bag within a shopping cart. At least one camera on or in the vicinity of the cart is cued to the motion of the item, acquires an image of the item and analyzes said item to identify it. Thereafter, image identity ledger is populated with the camera data. These two ledgers may be continually updated and compared as a shopper adds new items and removes existing bagged items. At the conclusion of the shopping trip, the two ledgers are compared and any discrepancies brought to retail staff's attention. Shopper may pay by any conventional means, via kiosk or via any phone/electronic payments modes.

Preferably, these steps are repeated on second and subsequent items, thereby creating a collated list of identified items with the receptacle (within one or more bags). Preferably, staff is notified where discrepancies are noted. Preferably, barcode data is acquired by any handheld electronic device. This includes the shopper's own Smartphones and retail operation-supplied barcode reader.

It is preferred that the image is recognized using one or more of:
pattern analysis
pel or pixel data pattern recognition
graphical analysis.

Most preferably, the image is acquired by at least one camera on or in the vicinity of the shopping receptacle, positioned to acquire such image prior to item being placed in the bag. The image may be acquired by a camera arrangement selected from the group consisting of one or more 3D cameras, one or more 2D cameras and combinations thereof. Preferably, the item is analyzed and identified by data from at least two cameras, the images from which (when compared) provide a depth metric for use in judging size of said item. In the alternative, a single camera with the appropriate software or a second camera plus depth, may also be used individually to gauge distance and therefore the size of an item. Two cameras are not necessarily required to acquire the depth metric.

In other words, by way of preferred camera arrangements and analyses, stereoscopic vision may be used to recover depth from camera images by comparing two or more views of the same item/image. This depth data or metric is used to identify the item. Thereafter, an algorithm estimates reliable and accurate depth maps from stereoscopic image pairs, which is based on block-matching techniques for disparity estimation. By taking neighboring disparity values into account, reliability and accuracy of the estimated disparity values are increased and the corona effect at disparity discontinuities is avoided. An interpolation of disparity values within segmented regions of homogeneous disparity enables the computation of dense depth maps by means of triangulation.

Depth information is obtained by a triangulation of corresponding image points with known stereoscopic camera parameters. Therefore, the coordinate difference between corresponding image points, called disparity, is estimated. Applying common block-matching techniques for disparity estimation, the correspondence of image points is evaluated using the cross correlation or mean absolute difference of corresponding image blocks.

In preferred situations, the shopper scans a barcode using a handheld electronic device (for example, a Smartphone), and then place these items in a shopping bag or another type of a bag used to hold groceries, in the shopping receptacle or simply in the receptacle itself. Preferably, one or more cameras placed on or in the vicinity of the shopping receptacle would (through motion sensing software) detect/notice movement of an item at the top of the receptacle (just before these are placed in a bag that is in the receptacle) and obtain one or more images of such an item as it is placed into the receptacle. The system would then (using pattern recognition software) determine the identity of the item and add such item to a ledger of items place in the receptacle. This list would after each item or periodically be checked with the list of items scanned (using an electronic handheld device or a Smartphone) by the shopper. If there are any differences, then the store staff would be notified of such items and/or a notice message could be generated for the shopper/consumer. FIG. 3 outlines each step of this embodiment of the invention.

One further aspect of the present invention provides a method of tracking and collating items being added to and removed from a shopping receptacle which comprises: receiving a cue that an item is in motion; upon such cue, receiving at least one collected colour image of the item; analyzing the image to identify the item; and creating a ledger of items in the shopping receptacle, said ledger comprising the identity of each item in the shopping receptacle. In this embodiment, barcode scanners are not employed and yet there is still the desire to easily, efficiently and accurately identify every individual item being laced into a shopping receptacle. A preferred form of this method combines the steps of scanning, analyzing and identifying the item, as noted above with a further step of comparing such item to a reference representation database to confirm identification with even greater certainty.

The reference representation database is a bank of data wherein 2D, 2D plus depth and optionally the 3D orientations and positions of the same and like image features are known and stored.

The reference representation database may be collected using any appropriate system for obtaining such 2D-3D correspondence, including, but not limited to binocular or multi-view image acquisition systems, range scanners or similar setups. It is most preferred than an item is “loaded” into the reference representation database from a plurality of orientations and from a plurality of light conditions thereby to detecting image features, such as edges, shading, gradients, curves, points, and apparent contours.

General multiple-camera disparity methods also form the basis for monocular Structure-from-motion 3D reconstruction software. Other 3D extraction methods include, but are not limited to:
Structured light scanners
LADAR augmented cameras
visual cues like luminosity gradients, or
coplanar feature matching, model fitting or generic “featureless” pose estimation.

The reference representation database of items may be stored in several different locations and with different types of systems, such as, but not limited to, locally on some non-volatile memory in a device utilizing the item recognition protocols described here according to the present invention; in a centralized server, e.g. a database server. Communication between the item recognition protocols and a reference representation database storage system may be utilized with different types of security levels and/or schemes, such as RADIUS, DIAMETER, SSL, SSH, or any other encrypted communication system as understood by the person skilled in the art.

In another embodiment of this invention, only the mobile device or the Smartphone's camera is used for image capture purposes. Accordingly, the camera would be controlled with software such that it is intermittently or continuously recording images. SUCH captured images would determine when the correct viewing angle perspective of the carts contents is available. Thus, the software would be able to ignore images which would be extraneous to the graphical analysis.

A smart-phone or mobile device enables the system to uniquely identify a consumer. Consumers could use a store issued shopper card, uniquely identifiable account number, a mobile phone number or other methods to register in the store's system at the start of the shopping trip. This allows a consumer to receive promotional offers like discounts, coupons, or advertising messages. Accordingly, promotions could be targeted based on items selected during the current shopping trip e.g., if the consumer is buying coffee than a complimentary offer could be made for coffee creamer. Additionally, data obtained from a sample of consumer Internet browsing activities and/or from a consumer's past purchases could be used to further target promotions during a shopping trip. For example, offer discounts or promotions on Coke since a consumer is a regular purchaser of Pepsi, or diet products would be promoted if Facebook social media consumer data inferred recent elevated interest in health, or joining a fitness center.

In another embodiment of this invention, the image obtained from a camera would be compared to prior stable image content, and similarities would be excluded to isolate changes that have occurred. This would isolate a minimal region of the new image which could contain items that are added, shifted position, or removed from the cart. This method would significantly reduce the computational task for a computer processor that would otherwise have to analyze the content of every image in its entirety. Additionally, regional image changes could be compared with each other to assist in the process of tracking which items remained in the specific shopping cart.

Some or all versions of this invention could include a motion sensor device or motion sensing software which would sense motion only in the region of interest i.e. the upper portion of the inside the cart. When it senses motion, an image would be obtained to determine if an item is being inserted or removed from the cart. While the item is in motion, an image would be obtained (from one or more cameras) and the identity of the item identified. Motion sensing will also enable the system to only obtain images of the full cart only after such movement has occurred to reduce the frequency of image acquisition and the resulting computer processing needs.

The software and or hardware of this system would also include features to detect and adjust for glare from overhead and other lights in the retail outlet or environment and vibration in the shopping cart as it is pushed during the shopping trip so that the system can adjust (using software and hardware) to adjust for any distortion in any images.

In another embodiment of this invention, a consumer would not be required to scan items selected from a shelf but just, as is currently done, place the items in the shopping cart. There would be monitoring cameras and/or 3D cameras placed in various positions of or in the vicinity of a cart. These cameras would relay all the images obtained from the various cameras directly to one or more networked servers/computers which would have detailed reference lists on all items in the store including UPC code, signature image data, and 3D volumetric information of consumer items. Computer vision software would use detection algorithms to determine if an item is present. Accordingly, the system would constantly record images of an item being placed or removed from the cart. Different viewing angles from cameras provide multiple images that provide enough visual image data to identify the item. Data on items placed inside a cart would then be compared to multiple samples of the history of this shopping trip for repeated verification of any missing items. A consumer may also be instructed to purposely scan one or more items on a camera within the cart where special lighting assists identifying an item.

In the embodiment described in the previous paragraph no consumer hand-held device or action is required for self-serve scanning of products. Therefore, an alternate approach would be used to identify a consumer. Consumers could enroll in the self-serve program by using a frequent shopper card issued by the store, credit card, debit card or cash checking card, registered mobile phone numbers, or some other method of identification. However, real-time customer assistance. Communicating with consumer of promotions and advertising, may still be required via a smart-phone or small computer screen/monitor affixed to the cart.

In this invention, purchased items that are uniquely packaged by the store may require a special bar-code or another identifiable image (that a camera can identify and the system can determine the contents of the package) to be affixed to packages of fresh produce, fruit, meats, deli items. Items such as clothing where the shape/form in the cart is not fixed and constantly changing, are not recognizable by conventional pattern recognition algorithms. These items may be marked or coded to generate a signal (i.e. radio frequency, infrared or other such signal) such that these items are identified for processing at the purchase kiosk at the end of a shopping trip.

In a further embodiment of the present invention, a shopper/user, in scanning an item using a Smartphone or other such electronic device may interact with either or both of a 1) promotions window/interface or 2) social media window/interface, each relating to the item selected. For example, details from an item manufacturer or information from competitive products may automatically be viewable by the shopper. A shopper may, via a social media window interact with other people about the item and make/hear/share information and recommendations

It is to be fully understood that the present methods, systems and devices also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

It is preferred that the versions and embodiments of this invention comprise a computer network where some or all the data may be transferred and processed. Such networks would comprise of handheld devices and/or Smartphones that are used by a shopper and/or cameras installed in or around a shopping receptacle. This network would support many shoppers shopping data concurrently transferred through retail locations.

Under this system a Smartphone, handheld device, camera and/or display device/screen is used by the shopper or is located in or around a shopping receptacle (referred to collectively hereinafter as “Initial Devices”) that obtains data. Therefore, the initial device is used to capture one or more images of a product and/or scans a UPC code from a product, and/or images of contents of the full shopping cart and other associated data (with the data hereafter being referred to as “Initial Data”). Some or all of the Initial Data (depending on the level of computer processing required) may be processed locally on a computer processor attached to the Initial Device, and/or communicated to a another computer or server where all or some or further data processing is done.

In a typical retail outlet, the Initial Devices would be connected to a network of computers via a hardwired, wireless LAN/WAN, internet TCP/IP, telephone, mobile phone WiFi/GSM/G3/G4 system or other such connections. Such a network may include several intermediate modems, routers or other such devices (“Connecting Devices) where the connection is wholly or partially wireless, uses infrared and/or mobile connectivity. There may be one or multiple such Connecting Devices between the Initial Devices and the computer/server where some or all of the data is processed. The Connecting Devices may also be designed to process all or part of the initial Data.

The Initial data may be processed at a local or central server ('Server”) where a reference list is available of item identity in terms of the detailed item data on its graphical properties, appearance, physical size, color, texture, orientation, etc. (referred to hereinafter as “Image Data”) UPC barcode (if required), price, promotions, advertising related to such item. The Initial Data shall be compared to such a reference list to identify the item and this will be communicated back to a device (smartphone, handheld device or just a display device/screen that is attached to the shopping receptacle for this purpose) where a list of items inserted in the shopping receptacle is being maintained for the shopper (these devices are collectively referred to herein as “Display Devices”).

As a consumer accumulates more items in the shopping receptacle, a ledger of items is maintained at the Display Devices and at the server and continuously reconciled. Furthermore, as the Initial Devices collect images on all the items in the whole shopping receptacle, then such images can be processed on the Initial Devices, Connecting Devices or the Server(s), to determine if the items on the ledger of items matches the items determined to be in the shopping receptacle. Some of the reference lists regarding item identity, any discounts or promotions relating to specific items or location of the shopper in the store, internet user data relating to a specific shopper, etc., may be maintained on servers located at or away from the retail outlet, and such servers may be networked with the local servers or directly to the Connecting Devices and the Initial devices.

While the forms of the method and system described herein constitute preferred embodiments of this invention, it is to be understood that the invention is not limited to these precise forms. As will be apparent to those skilled in the art, the various embodiments described above can be combined to provide further embodiments. Aspects of the present systems, methods and sensors (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

### EXAMPLE

### Example 1

### Sample Shopping Steps

1. A shopper enters a retail store and selects a wheeled shopping cart to assist in holding purchases.
2. This shopper already has an application (“App”) or other software on his/her Smartphone which enables the scanning, tracking and collating features of the present invention. The shopping carts in that store may be pre-marked with a barcode on the handle of the shopping cart and/or other distinctive markers or features in other areas (like the frame of the cart) on the cart.
3. The shopper, after starting the App (or other software in the Smartphone referred to herein as an App) firstly scans or takes a picture of the barcode or other identification marks or features on the cart to “link” or associate this particular shopper's Smartphone to a specific cart (as compared to all other carts in the store). If the shopping carts are not specifically marked, the Smartphone could be associated to a specific shopping cart as explained in paragraph 6 below.
4. The shopper then starts shopping and as the shopper takes an item from the store shelf, he/she scans it using the Smartphone and inserts the item in the cart.
5. During the shopping trip, enabled by either the App and/or software in the Smartphone the Smartphone camera automatically takes numerous pictures of the cart contents whenever the Smartphone camera is oriented or pointed towards the cart (this is done by the App in the Smartphone continually taking images which are the analyzed for the markers on the cart to determine if the image is of the inventory in a cart). Such pictures provide a snapshot of the inventory of the items in the cart which are determined by analyzing the images. Such a list of inventory of items in the cart is then compared with the list of items scanned by the shopper to identify any inconsistencies.
6. Alternatively or additionally, there are cameras or other image acquisition devices located in various locations in the retail store (for example, on or hanging from the ceiling, on store shelves, on end of store aisles, on store walls/floors, located in conjunction with store lighting so as to get pictures with the appropriate lighting for optimal image acquisition, etc.). Such cameras take pictures or acquire image of all the carts in the store moving in a particular camera's image acquisition zone. Each such image is analyzed for:
   a. Cart identity which by either the precise timing of an item scanned which is also identified by motion analysis of images obtained from the various cameras, for items inserted in a particular cart,
   b. by a particular pattern of items identified in each cart and comparing that to items scanned for each cart by the relevant Smartphone, or
   c. by marks, barcodes, special patterns, diagrams or other identifying markers placed on shopping receptacles/carts, which are identifiable/readable by image analysis of the images obtained by the cameras.
7. Once a cart is identified to a particular Smartphone being used by a shopper, the inventory lists from the camera image analysis is compared to the inventory list of items scanned by the consumer using the Smartphone and any inconsistencies identified and referred to retail staff for review with a shopper at checkout. Such comparison of inventory analysis is done multiple times and in multiple locations during a shopping trip. This includes comparing inventory from camera images in locations A versus B for a particular cart and reconciling this to items scanned during the intervening period.
8. The above process continues (repeatedly) until the shopper completes the shopping trip. At that point, the retail staff may address any scanning inconsistencies with the shopper and request the shopper to pay for the groceries.

We claim:

1. A method of tracking and collating items being added to and removed from a shopping receptacle which comprises:
a. receiving a cue that an item is in motion;
b. upon such cue, receiving at least one collected colour image of the item;
c. analyzing the image to identify the item; and
d. creating a ledger of items in the shopping receptacle, said ledger comprising the identity of each item in the shopping receptacle.

2. The method of claim 1 wherein the shopping receptacle is a shopping cart.

3. The method of claim 1 wherein the shopping receptacle is a shopping basket.

4. The method of claim 1 wherein the image is recognized using pattern analysis.

5. The method of claim 1 wherein the image is analyzed using at least one means of graphical analysis.

6. The method of claim 1 wherein the scanned image is created by one or more 3D cameras, one or more 2D cameras or combinations thereof in order to create volumetric data for use in analyzing the image at step c).

7. The method of claim 1 wherein the scanned item is identified by comparison to known historical references relating to other items having at least a similar physical appearance.

8. The method of claim 1 additionally comprising the step of storing the ledger and identity of each item, including price of each item, until recalled for checkout at a payment terminal.

9. A method of tracking and collating items being added to and removed from a shopping receptacle which comprises:
a). receiving a first cue that a first item is in motion;
b). upon such cue, receiving at least collected colour image of the first item;
c). analyzing the image to identify the first item;
d). creating a first stable ledger of all items in the shopping receptacle;
e). receiving a second cue that a second item is in motion;
f). upon such cue, receiving at least one collected colour image of the second item;
g). analyzing the image to identify the second item; and
h). creating a second, updated, stable ledger of items in the shopping receptacle.

10. The method of claim 9 wherein the shopping receptacle is a shopping cart.

11. The method of claim 9 wherein the shopping receptacle is a shopping basket.

12. The method of claim 9 wherein the image is analyzed using a system of pattern recognition.

13. The method of claim 9 wherein the image is analyzed using at least one means of graphical analysis.

14. The method of claim 9 wherein the scanned image is created by one or more 3D cameras, one or more 2D cameras or combinations thereof in order to create volumetric data for use in analyzing the image at step c). and g).

15. The method of claim 9 wherein the scanned items are identified by comparison to known historical references relating to other items having at least a similar physical appearance.

16. The method of claim 9 wherein steps a) to d) are successively repeated to create dynamically updated ledgers of shopping receptacle contents, including both items added to shopping receptacle and removed from shopping receptacle.

17. The method of claim 9 wherein steps a) to d) are successively repeated to create dynamically updated ledgers of shopping receptacle contents, including both items added to shopping receptacle and removed from shopping receptacle and wherein each successive item added to or removed from the shopping receptacle is separately tracked and collated.

18. The method of claim 1 wherein, at step b) the item is scanned by at least one camera attached to the shopping receptacle.

19. The method of claim 1 wherein, at step b) the item is scanned by at least one video camera attached to the shopping receptacle.

20. The method of claim 1 wherein the image is analyzed using pel or pixel data pattern recognition.

21. The method of claims 1 and 9 wherein the scanned image is created by a shopper operated mobile device selected from the group comprising a Smartphone, tablet and laptop computer.

22. The method of claims 1 and 9 wherein the scanned image is created by a data gathering devices attached or adjacent to said shopping receptacle.

23. The method of claims 1 and 9 wherein the scanned image is created by a combination of data gathering devices attached or adjacent to said shopping receptacle and a shopper operated mobile device.

24. The method of claims 21 and 23 wherein the mobile device selected from the group comprising a Smartphone, tablet and laptop computer.

25. A method of tracking and collating items being added to and removed from a shopping receptacle and checking out such items from a retail operation which comprises:
a) acquiring data from a shopper operated portable device, said data comprising a colour camera scan of an individual item sought to be purchased;
b) analyzing the image to identify the individual item (creating an item image identity);
c) repeating step a) and b) on second and subsequent items, thereby creating a collated list of identified items;
d) intermittently acquiring further data from a shopper operated portable device, said data comprising colour camera scans of contents of the shopping receptacle (creating a receptacle inventory image);
e) comparing the collated list of identified items to at least one receptacle inventory image; and
f) identifying discrepancies there between.

26. The method of claim 25 wherein the image is analyzed using pattern recognition software.

27. The method of claim 25 wherein the image is analyzed using at least one means of graphical analysis.

28. The method of claim 25 wherein the scanned image is created by a 3D camera, which provides volumetric data for use in analyzing the image at step b).

29. The method of claim 25 wherein the scanned item is identified by comparison to known historical references relating to other items having at least a similar physical appearance.

30. The method of claim 25 wherein the shopper operated portable device is selected from the group consisting of a Smartphone, tablet and laptop computer.

31. The method of claim 25 wherein the shopper operated portable device is locked to continually capture images.

32. A shopping receptacle comprising: a) at least means to detect movement of an item being inserted into and removed from the cart and b) at least means to capture and identify the image

33. The shopping receptacle of claim 32 additionally comprising a graphical marker to delineate a boundary space therein.

34. The shopping receptacle of claim 32 which is selected from the group consisting of a cart and a basket.

35. A retail system comprising a payment terminal, retail processor and retailer supplied shopping receptacle which comprises or is in the vicinity of at least one means to detect movement of an item as such item is inserted into and/or removed from the cart and comprises or is in the vicinity of at least one means to capture and identify an image of said item; said system further comprising a means to store a ledger of all captured images and means to identity each item based on said image, its price, and means to convey all data to retail processor over a communication network.

36. A method of tracking and collating items being added to a shopping receptacle, wherein items are placed in a bag within the shopping receptacle and thereafter checking out such items from a retail operation which comprises:
a) acquiring a barcode of an item sought to be purchased, before item is placed in the bag, to create a bar code ledger;
b) receiving a first cue that the item is in motion, as item is placed in the bag;
c) upon such cue, acquiring at least one collected colour image of the item;
d) analyzing the image to identify the individual item (creating an item image identity ledger);
e) comparing the bar code ledger and item image identity ledger; and
f) identifying any discrepancies there between.

37. The method of claim 36 which includes step g) repeating step a)-f) on second and subsequent items, thereby creating a collated list of identified items with the bag.

38. The method of claim 36 which includes notifying staff of the retail operation where discrepancies are noted as step f).

39. The method of claim 36 wherein barcode data is acquired by any handheld electronic device.

40. The method of claim 36 wherein barcode data is acquired by a device selected from the group comprising: Smartphone and retail operation-supplied barcode reader.

41. The method of claim 36 wherein the shopping receptacle is a shopping cart.

42. The method of claim 36 wherein the shopping receptacle is a shopping basket.

43. The method of claim 36 wherein the image is recognized using pattern analysis.

44. The method of claim 36 wherein the image is analyzed using pel or pixel data pattern recognition.

45. The method of claim 36 wherein the image is analyzed using at least one means of graphical analysis.

46. The method of claim 36 wherein the image is acquired by at least one camera on the shopping receptacle, positioned to acquire such image prior to item being placed in the bag.

47. The method of claim 36 wherein the image is acquired by a camera arrangement selected from the group consisting of one or more 3D cameras, one or more 2D cameras and combinations thereof.

48. The method of claim 47 wherein the item is analyzed and identified by data from at least two cameras, the images from which (when compared) provide a depth metric for use in judging size of said item.

49. The method of any of the preceding claims wherein some or all steps are executable by a computer.

50. A non-transitory computer storage medium encoding instructions that when executed by data processing apparatus cause the data processing apparatus to perform operations comprising:
a) receiving a cue that an item is in motion;
b) upon such cue, receiving at least one collected colour image of the item;
c) analyzing the image to identify the item; and
d) creating a ledger of items in the shopping receptacle, said ledger comprising the identity of each item in the shopping receptacle.

51. A non-transitory computer storage medium encoding instructions that when executed by data processing apparatus cause the data processing apparatus to perform operations comprising:
a). receiving a first cue that a first item is in motion;
b). upon such cue, receiving at least collected colour image of the first item;
c). analyzing the image to identify the first item;
d). creating a first stable ledger of all items in the shopping receptacle;
e). receiving a second cue that a second item is in motion;
f). upon such cue, receiving at least one collected colour image of the second item;
g). analyzing the image to identify the second item; and
h). creating a second, updated, stable ledger of items in the shopping receptacle.

52. A non-transitory computer storage medium encoding instructions that when executed by data processing apparatus cause the data processing apparatus to perform operations comprising:
a) acquiring data from a shopper operated portable device, said data comprising a colour camera scan of an individual item sought to be purchased;
b) analyzing the image to identify the individual item (creating an item image identity);
c) repeating step a) and b) on second and subsequent items, thereby creating a collated list of identified items;
d) intermittently acquiring further data from a shopper operated portable device, said data comprising colour camera scans of contents of the shopping receptacle (creating a receptacle image inventory);
e) comparing the collated list of identified items to at least one image of the receptacle image inventory; and
f) identifying discrepancies there between.

53. A non-transitory computer storage medium encoding instructions that when executed by data processing apparatus cause the data processing apparatus to perform operations comprising:
a) acquiring a barcode of an item sought to be purchased, before item is placed in a bag, to create a bar code ledger;
b) receiving a first cue that the item is in motion, as item is placed in the bag;
c) upon such cue, acquiring at least one collected colour image of the item;
d) analyzing the image to identify the individual item (creating an item image identity ledger);
e) comparing the bar code ledger and item image identity ledger; and
f) identifying any discrepancies there between.

54. A shopping receptacle comprising at least means to detect movement of an item being inserted into and removed from the cart, said receptacle being in operative engagement with at least means to capture and identify an image of the item.

55. A system for tracking and collating items being added to and removed from a shopping receptacle comprising:
a) a primary micro-processor within a motion detection device which receives data from a motion detector sensor that an item is in motion (in or out of receptacle);
b) the secondary micro-processor within an image capture device which receives a cue from the primary microprocessor that an item is in motion thereby triggering said secondary processor to i) capture an image of said item via an image capture means; ii) receive at least one collected colour image of the item; iii) analyze the image to identify the item; and iv) create a ledger of items in the shopping receptacle, said ledger comprising the identity of each item in the shopping receptacle.

56. A system for tracking and collating items being added to and removed from a shopping receptacle comprising:
a) a primary micro-processor within a motion detection device which receives data from a motion detector sensor that an item is in motion (in or out of receptacle);
b) the secondary micro-processor within an image capture device which receives a cue from the primary microprocessor that an item is in motion thereby triggering said secondary processor to i) capture an image of said item via an image capture means; ii) receive at least one collected colour image of the item; iii) analyze the image to identify the item; and iv) create a ledger of items in the shopping receptacle, said ledger comprising the identity of each item in the shopping receptacle.

57. The system of claim 56 wherein one or both of motion detection device and image capture device are attached to and form part of receptacle

58. The system of claim 56 wherein one or both of motion detection device and image capture device not are attached do not form part of receptacle but are in a vicinity of the receptacle.

59. The system of claim 56 wherein the image capture device is a camera, selected from the group consisting of:
a) at least one 3D camera on or in the vicinity of the shopping receptacle;
b) at least one 2D camera on or in the vicinity of the shopping receptacle; or
c) a combination of 3D and 2D cameras on or in the vicinity of the shopping receptacle.

60. The system of claim 56 wherein the image capture device is part of a personal mobile computer device.

61. The system of claim 56 wherein the primary microprocessor and the secondary microprocessor are securely connected for data sharing over the Internet.

62. The system of claim 56 wherein the primary microprocessor and the secondary microprocessor are securely connected for data sharing over an intranet.

63. A method of tracking and collating items being added to and removed from a shopping receptacle by a shopper and checking out such items from a retail operation which comprises:
a) linking a shopper operated portable device with the receptacle;
b) scanning, using the shopper operated portable device, a bar code of an item prior to or during placement of the item in the receptacle and storing inventory of scanned items (“scanned receptacle inventory”);
c) verifying that the item placed in the receptacle is bar code scanned, by at least one of the following means: i) acquiring data from the shopper operated portable device, said data comprising a colour camera image scan of the item in the receptacle, analyzing the image to identify the individual item (creating an item image identity); and ii) acquiring data from an image capture device in the vicinity of the receptacle, said data comprising a colour camera image scan of the item in the receptacle, analyzing the image to identify the individual item (creating an item image identity), either or both i) and ii) creating a “receptacle inventory image”:
d) repeating step b) and step c) on any second and subsequent items placed in the receptacle, thereby creating a collated list of identified items;
e) comparing the scanned receptacle inventory to at least one receptacle inventory image; and
f) identifying discrepancies there between, thereby flagging an item in the receptacle inventory image but not in the scanned receptacle inventory.

64. The method of claim 63 wherein a shopper operated portable device is equipped with an application enabling operation one or more of steps a) to e)

65. The method of claim 63 wherein a shopper operated portable device is a Smartphone.

66. The method of claim 64 wherein a shopper operated portable device is linked to the receptacle by scanning (using the device) an identifying feature of the receptacle and wherein said application enables a connection between the receptacle and the device.

67. The method of claim 63 wherein the shopping receptacle is a shopping cart.

68. The method of claim 63 wherein the shopping receptacle is a shopping basket.

69. The method of claim 63 wherein the step of analyzing the image to identify the individual item is via pattern analysis.

70. The method of claim 63 wherein the step of analyzing the image to identify the individual item is via at least one of the following means:
pel or pixel pattern analysis
graphic image recognition
3D analysis of packaging of the item
comparison of size and orientation of the item in the receptacle to a known feature of the receptacle

71. The method of claim 63 wherein the colour camera image scan of the item in the receptacle is created by one or more 3D cameras, one or more 2D cameras or combinations thereof thereby providing volumetric data for use in analyzing the image.

72. The method of claim 63 wherein the colour camera image scan of the item in the receptacle is identified by comparison to known historical references relating to other items having at least a similar physical appearance.

73. The method of claim 63 additionally comprising the step of storing the ledger and identity of each item, including price of each item, until recalled for checkout at a payment terminal.

74. The method of claim 63 wherein the image capture device in the vicinity of the receptacle is located at least one of the following locations in the retail operation: a ceiling, a floor, wall, a shelf, on signage, on a corner, attached to any fixture, attached to other items for sale; on posts, on displays, on remote robotic apparatus, and on employees.

75. The method of claim 63 wherein verifying that the item placed in the receptacle is bar code scanned is by at least one of the means of i) and ii) by which images are continually captured.

76. The method of claim 63 wherein verifying that the item placed in the receptacle is bar code scanned is by at least one of the means of i) and ii) by which images are intermittently captured.

77. The method of claim 63 at step c) ii), the image capture device in the vicinity of a receptacle identifies a particular receptacle (as compared to other receptacles in the retail operation) by at least one of the following:
a receptacle identification code
a receptacle identification feature
a comparison of a last scanned item at step b)
a comparison to a total inventory of scanned items at step b)
